(19) United States
(12) Patent Application Publication
(10) Pub. No.: US 2026/0030499 A1
(43) Pub. Date: Jan. 29, 2026

(54) Multi-Resolution Training for Latent Diffusion Models

(71) Applicant: GDM Holding LLC, Mountain View, CA (US)

(72) Inventors: Sander Etienne Lea Dieleman, London (GB); Hyunjik Kim, London (GB)

(21) Appl. No.: 19/278,173

(22) Filed: Jul. 23, 2025

Related U.S. Application Data
(60) Provisional application No. 63/676,208, filed on Jul. 26, 2024.

(51) Int. Cl. G06N 3/08; G06N 3/0455; G06T 3/4046

(52) U.S. Cl. CPC G06N 3/08; G06N 3/0455; G06T 3/4046

(57) ABSTRACT

Provided are systems and methods for training a latent diffusion model that involves two primary stages: training an autoencoder on lower-resolution images and then training a denoising diffusion model on higher-resolution images. As one example, the autoencoder can be trained on images with a resolution of 256×256 pixels or smaller, and subsequently, the diffusion model can be trained on images with a resolution of 512×512 pixels or larger (e.g., megapixel images such as 1024×1024 or larger).

### RELATED APPLICATIONS

This application claims priority to and the benefit of U.S. Provisional Patent Application No. 63/676,208, filed Jul. 26, 2024 and titled “MULTI-RESOLUTION TRAINING FOR LATENT DIFFUSION MODELS”. U.S. Provisional Patent Application No. 63/676,208 is hereby incorporated by reference in its entirety.

### FIELD

The present disclosure relates generally to machine learning. More particularly, the present disclosure relates to training autoencoders for latent diffusion models on lower-resolution input.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

Neural networks are a specific type of machine learning model that employ one or more layers of nonlinear units to predict an output for a received input. Some neural networks include one or more hidden layers in addition to an output layer. The output of each hidden layer is used as input to the next layer in the network, e.g., the next hidden layer or the output layer. Each layer of the network generates an output from a received input in accordance with current values of a respective set of parameters.

### SUMMARY

Aspects and advantages of embodiments of the present disclosure will be set forth in part in the following description, or can be learned from the description, or can be learned through practice of the embodiments.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method to train a latent diffusion model. The computer-implemented method includes training, by a computing system which may include one or more computing devices, an autoencoder model with a plurality of autoencoder training images. The autoencoder model may include an encoder model configured to generate a latent representation of an input image within a latent space and a decoder model configured to generate a reconstruction of the input image based on the latent representation of the input image generated by the encoder model. The plurality of autoencoder training images may have a first resolution. The method also includes after training, by the computing system, the autoencoder model based on the plurality of autoencoder training images, training, by the computing system, a denoising diffusion model with a plurality of diffusion model training images. The denoising diffusion model may be trained within the latent space of the autoencoder. The plurality of diffusion model training images may have a second resolution. The second resolution may be greater than the first resolution. The method also includes after training, by the computing system, the denoising diffusion model, outputting, by the computing system, at least the decoder model and the denoising diffusion model as the latent diffusion model. Other embodiments of this aspect include corresponding computer systems, apparatus, and computer programs recorded on one or more computer storage devices, each configured to perform the actions of the methods.

Example implementations may include any combination of one or more of the following features. The computer-implemented method where the method further may include: performing, by the computing system, one or more downsampling operations on a set of original images to generate the plurality of autoencoder training images. The plurality of autoencoder training images may include natural images. The first resolution may include 256×256 or smaller. The first resolution may include 224×224 or smaller. The second resolution may include 512×512 or larger. The second resolution may include 1024×1024 or larger. The encoder model and the decoder model may include resolution-flexible models. The encoder model and the decoder model may include fully convolutional models. The plurality of autoencoder training images may include a plurality of crops from a plurality of source images. The method further may include: performing, by the computing system, one or more downsampling operations on a set of original images to generate the plurality of source images. Performing, by the computing system, the one or more downsampling operations on the set of original images may include performing, by the computing system, two downsampling operations. Implementations of the described techniques may include hardware, a method or process, or computer software on a computer-accessible medium. The second resolution can include a greater total number of pixels than the first resolution. Training the autoencoder model can include optimizing a loss function that includes at least one of a reconstruction loss, a perceptual loss, or an adversarial loss. The denoising diffusion model can include a U-Net architecture. The autoencoder model can be a Vector-Quantized Variational Autoencoder (VQ-VAE).

Another aspect is directed to a system for generating images. The system includes a decoder model configured to generate an image from a latent representation in a latent space; and a denoising diffusion model configured to operate in the latent space to produce the latent representation. The decoder model includes a set of parameters optimized for reconstructing images of a first resolution, the optimization having been performed using a training set of images of the first resolution. The denoising diffusion model includes a set of parameters optimized using a training set of images of a second resolution, the second resolution being greater than the first resolution.

Another aspect is directed to a computer-implemented method to train a latent diffusion model for video. The method includes training an autoencoder model with a plurality of video sub-sequences, wherein each video sub-sequence comprises a subset of frames from an original video clip, thereby representing a first temporal resolution. The method includes, after training the autoencoder model, training a denoising diffusion model with a plurality of video clips having a second temporal resolution greater than the first temporal resolution, wherein the denoising diffusion model operates within a latent space of the autoencoder. The method includes outputting at least the decoder model and the denoising diffusion model.

Another aspect is directed to a computer-implemented method for generating a synthetic image. The method includes providing a latent diffusion model comprising a decoder model and a denoising diffusion model, wherein the latent diffusion model was trained as described herein. The method includes providing an input, comprising at least a random noise vector. The method includes processing the input with the denoising diffusion model to generate a denoised latent representation. The method includes processing the denoised latent representation with the decoder model to generate the synthetic image, the synthetic image having the second resolution.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIGS. 1A and 1B depict block diagrams of example techniques for training latent diffusion models according to example embodiments of the present disclosure.

FIG. 2 depicts example sources of autoencoder training images according to example embodiments of the present disclosure.

FIG. 3 depicts a flow chart diagram of an example method for training latent diffusion models according to example embodiments of the present disclosure.

FIG. 4A depicts a block diagram of an example computing system according to example embodiments of the present disclosure.

FIG. 4B depicts a block diagram of an example computing device according to example embodiments of the present disclosure.

FIG. 4C depicts a block diagram of an example computing device according to example embodiments of the present disclosure.

Reference numerals that are repeated across plural figures are intended to identify the same features in various implementations.

### DETAILED DESCRIPTION

Example aspects of the present disclosure are directed to systems and methods for training a latent diffusion model that involves two primary stages: training an autoencoder on lower-resolution images and then training a denoising diffusion model on higher-resolution images. As one example, the autoencoder can be trained on images with a resolution of 256×256 pixels or smaller, and subsequently, the diffusion model can be trained on images with a resolution of 512×512 pixels or larger (e.g., megapixel images such as 1024×1024 or larger).

This approach can be beneficial for enhancing the fidelity of the images ultimately generated using the latent diffusion model. As used herein, the term “fidelity” can refer to the accuracy and detail with which an image reproduces the fine-grained texture and structure of the original subject or scene. High fidelity in an image means that the subtle details and nuances are preserved and clearly represented, allowing for a more precise and true-to-life depiction.

More particularly, latent diffusion models represent a significant advancement in the field of image processing and machine learning. These models operate by first learning a latent representation of input data, such as images, through an autoencoder. The autoencoder compresses the input into a compact latent space, capturing essential features and patterns. Subsequently, a diffusion model is trained within this latent space to generate or reconstruct images. This two-stage process allows for efficient handling of complex image distributions and can produce high-quality synthetic images. The use of latent diffusion models has become increasingly popular in various applications, including image enhancement, synthesis, and analysis, due to their ability to effectively manage and manipulate high-dimensional data.

In conventional training pipelines for latent diffusion models, it is common practice to train both the autoencoder and the subsequent denoising diffusion model on datasets of images having the same, often high, resolution. This approach, however, suffers from significant drawbacks. Training the autoencoder on high-resolution images is computationally expensive and, more critically, can lead to suboptimal image fidelity. When trained on high-resolution images, the autoencoder's reconstruction loss is often dominated by low-frequency global structures, causing the model to neglect the fine-grained, high-frequency textures that define image quality. This results in a latent space that fails to effectively capture high-fidelity details. Consequently, images generated from this latent space often exhibit a “blurry” or “over-smoothed” appearance in detailed regions, a fundamental problem that cannot be fully corrected by the subsequent diffusion model because the necessary high-fidelity information was never properly encoded in the first place. Thus, there is a need for an improved training methodology to overcome these deficiencies in the art.

In view of the above challenges, one example aspect of the present disclosure is directed to training an autoencoder model using autoencoder training images that have a relatively smaller resolution (e.g., as compared to images used to train the diffusion model). This approach can be particularly advantageous as it allows the autoencoder to concentrate on learning to encode and decode fine-grained details and/or textures from lower-resolution images. By focusing on these features, the autoencoder can learn to generate a more accurate and detailed latent representation of the input images. This latent representation can then be effectively utilized by the subsequent latent diffusion model to produce high-fidelity images at a higher resolution, ultimately enhancing the overall quality and realism of the generated images of the higher resolution.

As used herein, the term “resolution” can refer to the size of an image, which is often quantified by the number of pixels it contains. Resolution is typically expressed in terms of width and height, with the unit of measurement being pixels. For example, an image with a resolution of 256×256 pixels has 256 pixels in width and 256 pixels in height. A pixel can include values for one or more channels (e.g., three channels such as, for example, a red channel, a blue channel, and a green channel).

In some implementations, the autoencoder model described in the present disclosure can include an encoder model and a decoder model. The encoder can be configured to encode an input image into a latent representation expressed within a latent space. The decoder can be configured to decode from a latent representation within the latent space to an image (e.g., a reconstruction of the original input image).

According to an aspect of the present disclosure, the encoder and decoder models can be resolution-flexible models, which allows them to handle various image resolutions effectively. This flexibility is particularly beneficial in applications where images of different resolutions and qualities are processed. For example, the models can adapt to lower resolutions used during the autoencoder training and then seamlessly transition to handle higher resolutions used in the diffusion model training. This adaptability enhances the models' utility across various scenarios without the need for reconfiguration or extensive modifications to accommodate different image resolutions.

In some implementations, the encoder and decoder models can be fully convolutional and/or incorporate local attention mechanisms. Fully convolutional models offer the advantage of being inherently resolution-flexible, which enables them to process input images of any size without requiring input reshaping or resizing. This characteristic is particularly useful for maintaining the integrity and quality of image details across different processing stages. On the other hand, local attention mechanisms can be designed to be resolution-flexible, allowing them to dynamically adjust their focus on different areas of an image regardless of its resolution. Models employing local attention mechanisms can focus on specific regions of an image, thereby enhancing the model's ability to capture and emphasize important features and patterns within these regions.

While the principles disclosed herein are broadly applicable, they can be implemented using specific neural network architectures. For example, in some implementations, the autoencoder model, comprising the encoder and decoder, can be based on a Vector-Quantized Generative Adversarial Network (VQ-GAN) architecture or a Vector-Quantized Variational Autoencoder (VQ-VAE) architecture. The denoising diffusion model, in turn, can be implemented using a U-Net architecture. This U-Net can be augmented with cross-attention layers to process conditioning inputs, such as text embeddings derived from language models (e.g., CLIP), thereby enabling the generation of images or videos based on descriptive text prompts. The use of these or similar architectures provides a practical framework for realizing the multi-resolution training methods described herein.

The training process for the autoencoder model in the present disclosure can utilize a variety of loss terms to optimize performance. These loss terms can include reconstruction loss (e.g., mean squared error), a perceptual loss (e.g., LPIPS), and/or an adversarial loss (e.g., GAN loss). The inclusion of an adversarial loss is particularly beneficial for reducing the blurriness in the reconstructed images, thereby improving the overall image fidelity.

After the autoencoder has been trained, a denoising diffusion model can then be trained within the latent space of the autoencoder. The diffusion model can be trained using relatively higher resolution images (e.g., as compared to the images used to train the autoencoder). As a result, the diffusion model can produce outputs that are not only high in fidelity but also rich in textural and structural nuances, making them more visually appealing and realistic. Thus, the present disclosure provides for the efficient use of varying resolutions to optimize the quality of image generation in different stages of the modeling process.

The present disclosure also provides methods for preparing the training datasets for both the autoencoder and the diffusion model. For example, the training images for the autoencoder can be derived from a variety of sources. In some implementations, they can include natural images or crops from a larger set of source images. In some implementations, for the autoencoder, one or more downsampling operations can be performed on a set of original images to generate the autoencoder training images. These operations can help in generating lower-resolution images that contain fine-grained details. For instance, two consecutive downsampling operations might be applied to adjust the image resolution to the desired level for autoencoder training.

Once trained, the latent diffusion model can be used to generate synthetic images. For example, these images can be produced at the same higher resolution as used in the diffusion model training. The ability to generate high-resolution synthetic images is particularly useful in fields such as graphic design, animation, and other visual media applications.

In addition to static images, the technology described in the present disclosure can also be applied to video content. By training the latent diffusion model with video frames as input, it is possible to generate synthetic video sequences. This can be particularly advantageous for creating realistic and high-fidelity visual effects or for use in virtual reality environments.

In particular, the latent diffusion model can be adapted to address the unique challenges presented by the temporal dimension of videos. This can include application of techniques that go beyond treating video frames as independent images, thereby enabling the model to capture and synthesize the dynamic aspects of video sequences effectively.

As one example, in some implementations, a training approach (e.g., when training the autoencoder model on video data) can include or perform frame dropping. Frame dropping is in some ways analogous to the spatial down-sampling used for single images and described herein. For example, by selectively training on subsets of frames, the model learns to represent and reconstruct video sequences even when frames are missing, effectively handling variations in temporal resolution. Thus, frame dropping can be thought of as multi-resolution training in time.

Additionally or alternatively, in some implementations the latent diffusion model (e.g., the autoencoder portion of the model) can employ convolutions across the time axis, allowing it to compress and encode temporal information. The use of temporal convolutions not only captures spatial features within individual frames but also patterns and changes across frames, improving temporal continuity. The proposed approaches can also preserve the ability of the autoencoder to generalize to an arbitrary number of input frames, which provides flexibility in handling video content of varying lengths and dynamics without needing to retrain the model for different temporal resolutions.

To provide a concrete implementation for video processing, the autoencoder can employ 3D convolutional layers (Conv3D) that operate across both the spatial dimensions (e.g., height and width) and the temporal dimension (e.g., time). During the autoencoder training phase, which constitutes temporal multi-resolution training, the model can be provided with a sub-sequence of frames (e.g., 8 frames randomly selected from a 30-frame clip) and tasked with reconstructing that same sub-sequence. By training the model on many such randomly dropped or selected sub-sequences, the autoencoder learns a robust temporal representation that is capable of interpolating missing information and generalizing to video clips of arbitrary length. The subsequent denoising diffusion model can then be trained on full-length or higher-frame-rate video clips within the latent space established by this temporally-aware autoencoder.

Thus, the present disclosure provides a unique approach to training a latent diffusion model in which the autoencoder is trained on images having a relatively lower resolution while the diffusion model is trained on images having a relatively higher resolution. This method leverages the strengths of both training phases by optimizing the autoencoder to focus on fine-grained details at a lower resolution. Subsequently, the diffusion model utilizes the learned latent representations to generate high-resolution images with improved fidelity and richness.

The present disclosure provides a counter-intuitive, yet effective approach in the training of autoencoders for latent diffusion models, where the autoencoder is trained on lower-resolution images compared to the higher resolutions used for the diffusion model. In particular, in prior works it was consistently presumed that matching the resolutions of the autoencoder training images and the diffusion model training images would yield optimal results.

However, the systems and methods of the present disclosure recognize that using lower-resolution images for training the autoencoder actually leads to higher fidelity in the generated images. This improvement in fidelity can be attributed to the fact that lower-resolution images allow the autoencoder to focus more effectively on capturing and representing high-fidelity, fine-grained details such as small facial features and text. These details are often lost or obscured in higher-resolution images that contain a mix of high and poor-fidelity elements.

The technical mechanism underlying this improvement in fidelity can be attributed to the relative prominence of high-frequency details in lower-resolution training data. In a downsampled or cropped low-resolution image, fine-grained features, such as the texture of fabric, individual strands of hair, or small text, occupy a larger relative portion of the total pixel area. Consequently, the reconstruction loss function, when calculated, places a greater emphasis on accurately reconstructing these details to minimize overall error. In contrast, when training on a full high-resolution image, these same details may represent a smaller fraction of the total pixels. In such a case, their contribution to the overall loss can be overwhelmed by the need to reconstruct larger, lower-frequency structures, leading the autoencoder to prioritize global coherence at the expense of local fidelity.

Thus, by training the autoencoder with these lower-resolution images, the autoencoder learns to efficiently encode/decode these fine-grained details into/from the latent space. The diffusion model can then operate within the learned latent space to generate images of higher overall fidelity and resolution.

The systems and methods of the present disclosure provide a number of technical effects and benefits. Specifically, the present disclosure addresses a specific technical problem in the field of machine learning, particularly in the training of latent diffusion models for image generation. The technical problem involves optimizing the fidelity of generated images while efficiently managing computational resources during the training process. Traditionally, both the autoencoder and diffusion model were trained using high-resolution images, which often contained a mix of high and low-fidelity data, leading to suboptimal training outcomes and increased computational load.

In view of this technical problem, one technical solution of the present disclosure is to train the autoencoder on lower-resolution images, which significantly enhances the fidelity of the images generated by the diffusion model trained subsequently at a higher resolution. This approach not only improves the quality of the generated images by focusing on high-fidelity, fine-grained details but also reduces the computational resources required during the autoencoder training phase. In particular, by training the autoencoder using lower-resolution images, fewer computational resources are consumed as compared to performing the same training using higher-resolution images (e.g., due to fewer floating point operations or other model computations being performed).

Thus, by training the autoencoder on lower-resolution images, the computational burden of this training stage can be significantly reduced, requiring fewer floating point operations and less memory compared to training on high-resolution data. This allows for more efficient utilization of specialized hardware such as Graphics Processing Units (GPUs) or Tensor Processing Units (TPUs), which are adapted for the parallel processing inherent in neural network training. Furthermore, this approach creates a latent space that is optimized for high-fidelity details, leading to a tangible improvement in the quality of the final high-resolution images generated by the diffusion model. This two-stage, multi-resolution approach represents a specific improvement to computer functionality, enabling the generation of higher-quality media with greater computational efficiency.

The disclosed methods and systems can be specifically integrated into various technical applications such as, for example, robotics and reinforcement learning for physical-world agents. As one example, a robotic agent, such as a manipulator arm in a manufacturing setting or an autonomous vehicle, can be trained in a simulated environment. The multi-resolution training technique can be used to generate high-fidelity, high-resolution visual data of the simulated environment, which serves as training data for a control policy. By training a reinforcement learning agent on this diverse, synthetically generated data, the agent can learn to perform complex tasks (e.g., object grasping, navigation) more robustly before being deployed in the real world. In another example application, the model can receive inputs from the robot's sensors (e.g., LiDAR, camera data) and a high-level command (e.g., a natural language instruction like “pick up the red block”), and generate a sequence of high-fidelity predicted future states or a sequence of control commands that constitute a policy for executing the task, thereby improving the safety and efficacy of the robotic system.

With reference now to the Figures, example embodiments of the present disclosure will be discussed in further detail.

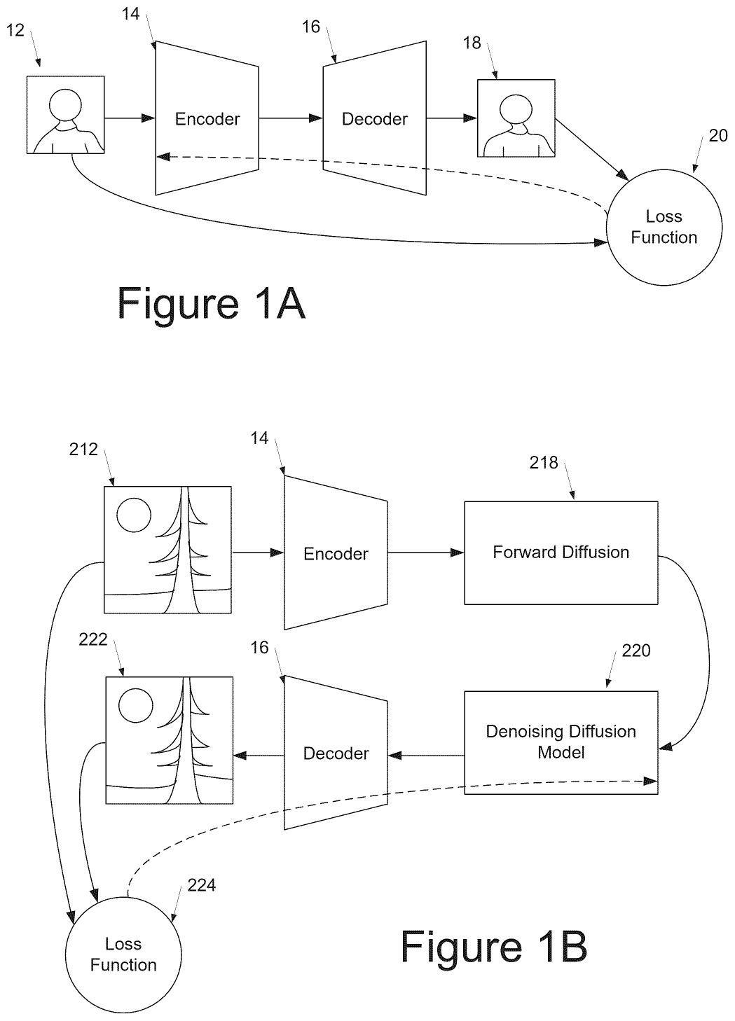

Referring now to FIG. 1A, the diagram shows a training process for an autoencoder model as described in the present disclosure. An autoencoder training image 12, which can be of relatively lower resolution, is input into an encoder 14. The autoencoder training image 12 can vary in size depending on specific requirements and settings of the training process. Common sizes for the autoencoder training image 12 can include resolutions such as 256×256 pixels or smaller. In some implementations, the size can be reduced to 224×224 pixels or even smaller to focus on essential details during the encoding process. Alternative sizes, such as 128×128 pixels or 64×64 pixels, can also be used to accommodate different computational constraints or to target specific features within the training dataset. These variations in size allow the autoencoder to adapt to various levels of detail and image complexity.

The autoencoder training image 12 can be sourced from various origins. It can include natural images, such as photographs of landscapes or urban scenes. Alternatively, it can consist of synthetic images generated by computer graphics techniques. The autoencoder training image 12 can also be derived from specific datasets tailored for particular applications, such as medical imaging or satellite imagery. In some implementations, the autoencoder training image 12 can be a crop or a modified version of a larger original image, adjusted to meet specific training requirements. This flexibility in sourcing allows for customization of the training process to optimize the performance of the autoencoder model across different scenarios.

The encoder 14 compresses the autoencoder training image 12 into a latent space representation. This process captures essential features of the autoencoder training image 12 and reduces its dimensionality. The encoder 14 can be designed using various resolution-flexible architectures to accommodate different image resolutions effectively. One example architecture is the fully convolutional network, which can handle input images of any size without the need for pre-defined dimensions. Another option is the use of adaptive pooling layers, which allow the network to maintain spatial hierarchies at different resolutions. Additionally or alternatively, encoder 14 can incorporate local attention mechanisms. These mechanisms focus processing power on specific areas of an image, improving the model's ability to capture important details at varying resolutions.

A decoder 16 then receives the latent representation and tries to reconstruct the original image, producing a reconstructed autoencoder training image 18. The decoder 16 can be designed with resolution-flexible architectures to accommodate varying image resolutions. Such architectures can include fully convolutional networks, which do not require fixed input sizes and can adapt to different dimensions of input data. Alternatively or additionally, the decoder can employ adaptive pooling layers that adjust the spatial dimensions of feature maps to match required output sizes. Another option is the use of local attention mechanisms, which allow the decoder to focus on specific areas of the input regardless of its overall size. These resolution-flexible approaches ensure that the decoder 16 can effectively reconstruct images from their latent representations across a broad range of resolutions.

A loss function 20 evaluates the fidelity of the reconstructed image 18 relative to the original autoencoder training image 12. The loss function 20 used in the training process of the autoencoder model can be implemented in various ways depending on the specific requirements of the application. As an example, it can include mean squared error (MSE) to measure the pixel-wise differences between the original and reconstructed images. Alternatively, perceptual loss, which assesses discrepancies in content and style features extracted from pre-trained convolutional networks, can be utilized. For applications requiring preservation of textural details, structural similarity index (SSIM) or multi-scale structural similarity index (MS-SSIM) can be employed. Additionally, adversarial loss components, derived from generative adversarial network (GAN) frameworks, can be incorporated to enhance the perceptual quality of the reconstructed images. Each of these loss components can be used individually or in combination to optimize the encoder and decoder performance, tailoring the training process to achieve desired outcomes in image fidelity and quality.

The loss function 20 can be utilized to update the parameter values of the encoder 14 and the decoder 16 through backpropagation. For example, during this process, the loss function 20 calculates the error between the reconstructed autoencoder training image 18 and the original autoencoder training image 12. This error can then be used to adjust the parameters of the encoder 14 and decoder 16 to minimize the reconstruction error (or other loss terms). A backpropagation method can apply gradients derived from the loss function 20 to update the parameters, thereby refining the models' performance over successive training iterations.

Referring now to FIG. 1B, the figure illustrates a subsequent training stage involving a diffusion model, using the encoder 14 and decoder 16 previously trained as shown in FIG. 1A.

A diffusion training image 212, usually of higher resolution than the autoencoder training image 12, is processed by the same encoder 14 to generate a latent representation. The diffusion training image 212 can vary in size depending on specific application requirements. Typically, the resolution of diffusion training image 212 is higher than that of the autoencoder training image 12. For example, while the autoencoder training images may be 256×256 pixels or smaller, the diffusion training images can be 512×512 pixels or larger. In some implementations, the diffusion training images can be as large as 1024×1024 pixels or even larger. This variation in size allows the diffusion model to train on images with more detailed and complex features, which is beneficial for applications requiring high-resolution image output.

The diffusion training image 212 can be sourced from a variety of origins depending on the intended application of the diffusion model. These images can include natural scenes, medical imaging data, satellite photographs, or artificially generated images. In some cases, the diffusion training images 212 can be derived from existing databases that are publicly available or proprietary collections specifically curated for training purposes. Additionally, these images can be pre-processed or modified to fit specific training requirements, such as resizing or enhancing image features critical for the diffusion process. This flexibility in sourcing allows for the adaptation of the training process to different domains and objectives.

The latent representation generated for the diffusion training image 212 by the encoder 14 is subjected to a forward diffusion process 218, designed to incrementally add noise, simulating a diffusion process. The noisy latent representation is then input into a denoising diffusion model 220, which seeks to reverse the diffusion process and recover a denoised latent representation. The decoder 16 reconstructs the image from this denoised latent representation, resulting in a reconstructed diffusion training image 222.

A loss function 224 assesses the quality of this reconstruction and guides the training of the denoising diffusion model 220. Loss function 224 can be implemented in various ways to assess the quality of the reconstructed diffusion training image 222. It can include metrics such as Mean Squared Error (MSE), Structural Similarity Index (SSIM), or Perceptual Loss, which evaluates differences in content and style between images. The choice of loss function can depend on the specific requirements of the application. For example, MSE can be used for applications requiring pixel-level accuracy, while Perceptual Loss might be preferred in scenarios where maintaining textural and stylistic fidelity is more critical. Additionally, loss function 224 can be configured to weight different aspects of the reconstruction differently, thereby optimizing the denoising diffusion model 220 according to specific performance criteria.

Loss function 224 can be utilized to train the denoising diffusion model 220 through backpropagation. For example, during training, the loss function 224 calculates the error between the reconstructed diffusion training image 222 and the original diffusion training image 212 (or other loss terms). This error measurement can be backpropagated through the denoising diffusion model 220 to adjust and optimize its parameters. The adjustments aim to minimize the error in subsequent iterations, enhancing the model's ability to accurately denoise and reconstruct images. This process can be iterative, with each cycle refining the model's performance based on the feedback provided by the loss function 224.

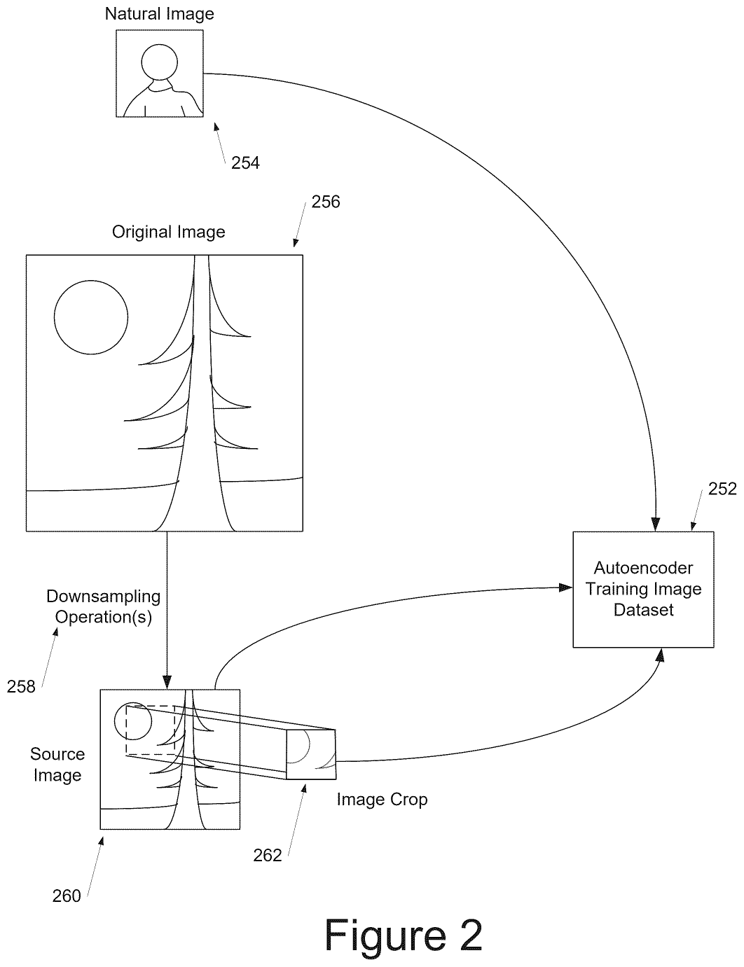

Referring to FIG. 2, the diagram illustrates various types of images that can optionally be included in an autoencoder training image dataset 252, which is used to train the autoencoder (e.g., as illustrated in FIG. 1A). The types of images shown offer examples of how the training dataset can be constructed from different sources and through various processing steps. Any combination of some or all of these or other images can be used to train the autoencoder. Each of these image types contributes to the diversity and comprehensiveness of the autoencoder training image dataset 252.

A natural image 254 of lower resolution is depicted as one type of image that can be included in the dataset. This image 254 can represent a straightforward, unaltered example of a typical input image that retains its original resolution, which is generally lower than the resolution used for training the diffusion model. A “natural image” generally refers to a photograph taken in uncontrolled environments, often depicting scenes or subjects as found in everyday life without any artificial alteration or studio enhancement. These images capture real-world conditions and are typically used to represent common visual experiences encountered by humans.

An original image 256 is shown as another example image type. This image can serve as a baseline or reference image from which other forms of processed images are derived. The original image 256 is typically of higher resolution (e.g., greater than one megapixel) and can undergo various transformations to prepare it for inclusion in the training dataset.

In particular, downsampling operations 258 can be applied to the original image 256 to generate a source image 260. In some implementations, the source image 260 can be added to or included in the autoencoder training image dataset 252.

Additionally or alternatively, specific portions from the source image 260 can be selected for training the autoencoder. Specifically, an image crop 262 is shown as a segment extracted from the source image 260. This cropping process allows for the isolation of particular features or areas of interest within the larger image. In some implementations, the image crop 262 can be added to or included in the autoencoder training image dataset 252.

To provide an example, original images 256 used to construct the training dataset might range from slightly over one megapixel to several megapixels in size, such as 2 megapixels (1920×1080), 4 megapixels (2560×1440), or even higher resolutions like 8 megapixels (3264×2448) or more. These larger dimensions ensure that sufficient detail is captured, providing a robust basis for downsampling operations 258 and other preprocessing steps.

In one example, consider an original image 256 with a resolution of 1024×1024 pixels. To prepare this image for inclusion in the autoencoder training image dataset, two downsampling operations are performed. Each downsampling operation reduces the resolution of the image by a factor, typically to enhance the focus on essential details rather than high-resolution specifics which may be less beneficial for the autoencoder's training.

The first downsampling operation might reduce the resolution by half, resulting in an intermediate image of 512×512 pixels. Subsequently, a second downsampling operation is applied to the intermediate image, further reducing its resolution by half once again. This results in a source image 260 with a resolution of 256×256 pixels. At this reduced resolution, the image retains important visual information but with reduced data redundancy, which can facilitate more efficient learning by the autoencoder.

This source image 260, now at a significantly lower resolution than the original, is better suited for training the autoencoder. It allows the model to concentrate on learning to encode and decode the fundamental aspects of the images, which assists in ultimately generating high-fidelity reconstructions at potentially higher resolutions during the diffusion model training phase.

To continue the example, the image crops 262 taken from the source image 260 can be 224×224 crops. Furthermore, although image crops 262 are shown being taken from the source image 260; image crops can additionally or alternatively be taken from the natural image 254.

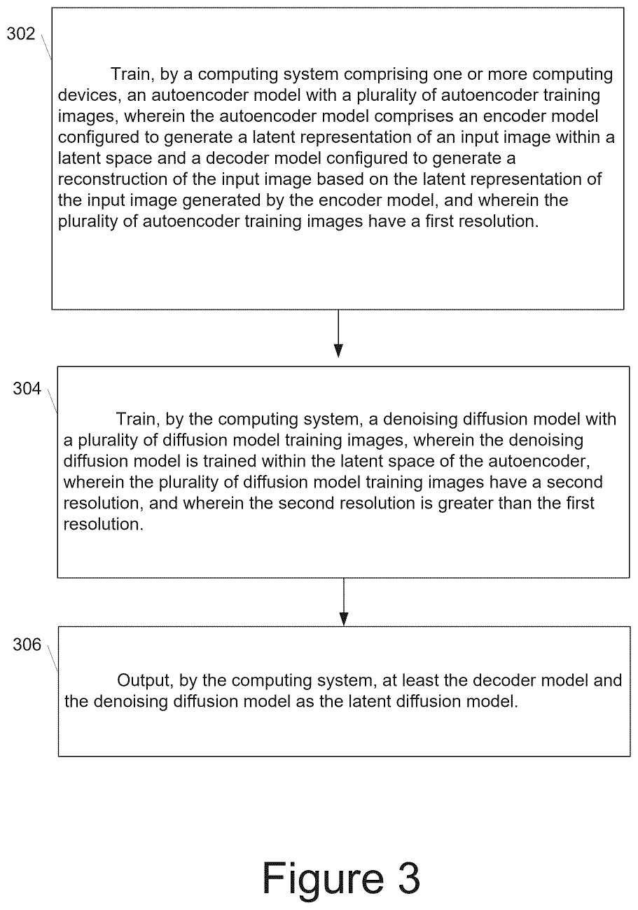

FIG. 3 depicts a flowchart diagram of an example method for training a latent diffusion model. The method begins with step 302, where a computing system comprising one or more computing devices trains an autoencoder model. This model includes an encoder model configured to generate a latent representation of an input image within a latent space. Additionally, a decoder model can generate a reconstruction of the input image based on the latent representation generated by the encoder. The training utilizes a plurality of autoencoder training images, which have a first resolution. These images can be natural images or crops from a set of source images. The source images may have undergone one or more downsampling operations to achieve the desired resolution. As one example, the first resolution can be 256×256 pixels or smaller.

Following the training of the autoencoder model, step 304 includes training a denoising diffusion model by the computing system. This diffusion model is trained within the latent space established by the previously trained autoencoder model. The training uses a plurality of diffusion model training images that have a second resolution, which is greater than the first resolution used for the autoencoder training images. As examples, this second resolution can be 512×512 pixels or larger, and potentially as large as 1024×1024 pixels or more.

Step 306 includes the computing system outputting at least the decoder model and the denoising diffusion model as components of the latent diffusion model. This model is capable of generating synthetic images that maintain the second, higher resolution.

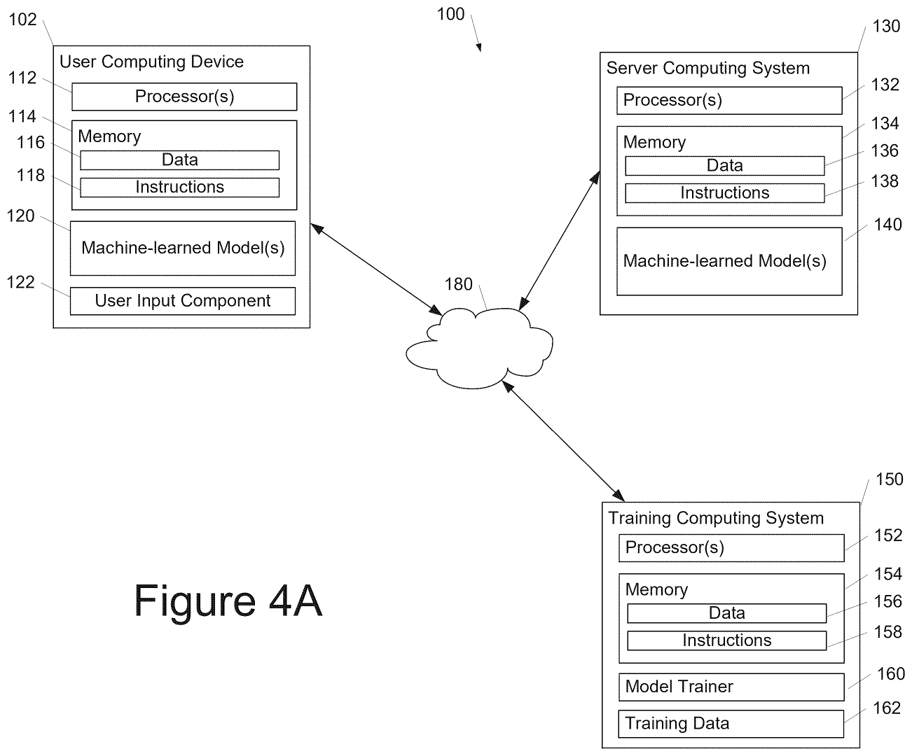

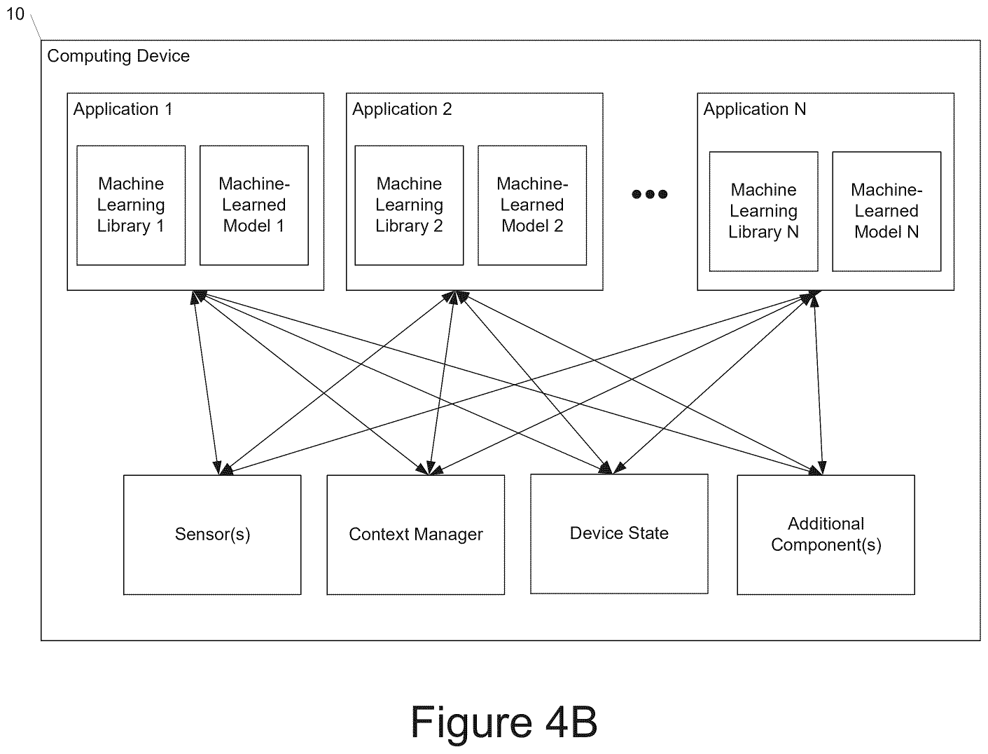

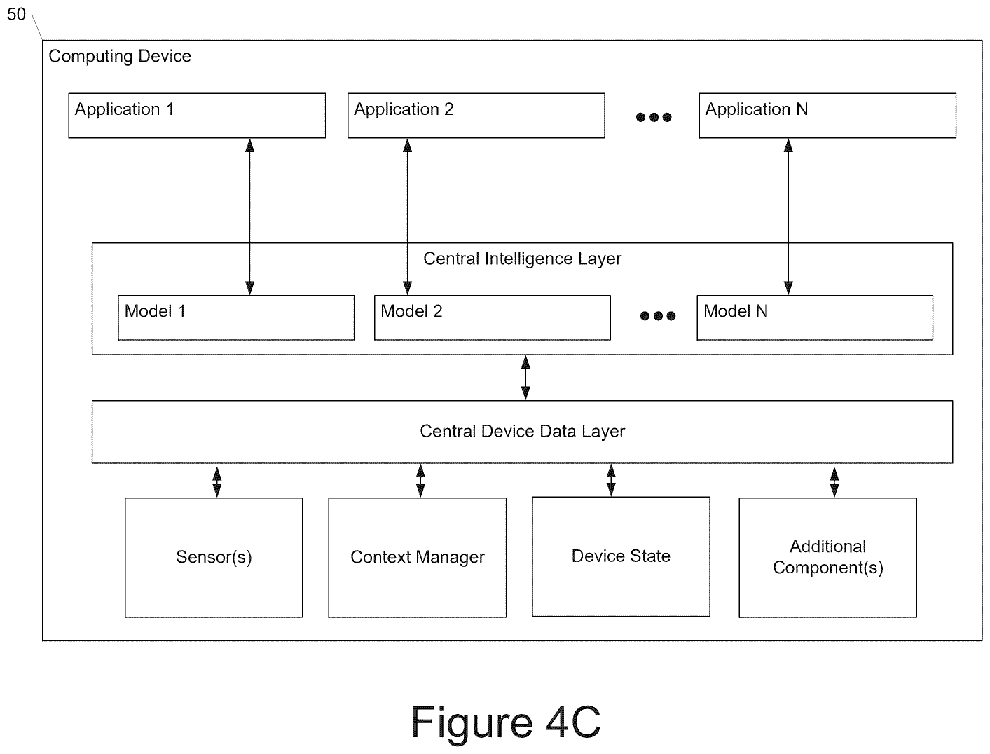

FIG. 4A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to the preceding Figures.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel image generation across multiple instances of prompts or inputs).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 130 as a portion of a web service (e.g., an image generation service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to the preceding Figures.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media. For example, model trainer 160 can be configured to perform the training methods described herein such as the training methods discussed with reference to the preceding Figures.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

In some implementations, the input to the machine-learned model(s) of the present disclosure can include visual data, and the task is a computer vision task. Specifically, diffusion models can be employed in various image processing tasks. For example, diffusion models can be used in image classification, where the output is a set of scores. Each score corresponds to a different object class and represents the likelihood that one or more images depict an object belonging to that class. Another application involves object detection, where the output identifies regions in one or more images and provides a likelihood for each region that it depicts an object of interest.

One example type of machine learning model (e.g., model 120 and/or 140) is a denoising diffusion model (or “diffusion model”). A denoising diffusion model can be defined as a type of generative model that learns to progressively remove noise from a set of input data to generate new data samples. A comprehensive discussion of diffusion models is provided by Yang L., Zhang Z., Song Y., Hong S., Xu R., Zhao Y., Zhang W., Cui B., and Yang M., Diffusion Models: A Comprehensive Survey of Methods and Applications, arXiv: 2209.00796 [cs.LG]. See also, Sohl-Dickstein, J., Weiss, E., Maheswaranathan, N., & Ganguli, S. (2015). Deep Unsupervised Learning using Nonequilibrium Thermodynamics. In International Conference on Machine Learning (ICML); Song, Y., & Ermon, S. (2019). Generative Modeling by Estimating Gradients of the Data Distribution. In Advances in Neural Information Processing Systems (NeurIPS); Ho, J., Jain, A., & Abbeel, P. (2020). Denoising Diffusion Probabilistic Models. In Advances in Neural Information Processing Systems (NeurIPS); and Song, Y., Sohl-Dickstein, J., Kingma, D. P., Kumar, A., Ermon, S., & Poole, B. (2020). Score-Based Generative Modeling through Stochastic Differential Equations. In International Conference on Learning Representations (ICLR).

More particularly, in some implementations, the diffusion process of a denoising diffusion model can include both forward and reverse diffusion phases. The forward diffusion phase can include gradually adding noise (e.g., Gaussian noise) to data over a series of time steps. This transformation can lead to the data eventually resembling pure noise. For example, in the context of image processing, an initially clear image can incrementally receive noise until it is indistinguishable from random noise. In some implementations, this step-by-step addition of noise can be parameterized by a variance schedule that controls the noise level at each step.

Conversely, the reverse diffusion phase can include systematically removing the noise added during the forward diffusion to reconstruct the original data sample or to generate new data samples. This phase can use a trained neural network model to predict the noise that was added (or conversely, that should be removed) at each step and subtract it from the noisy data. For instance, starting from a purely noisy image, the model can iteratively denoise the image, progressively restoring details until a clear image is obtained.

This process of reverse diffusion can be guided by learning from a set of training data, where the model learns the optimal way to remove noise and recover data. The ability to reverse the noise addition effectively allows the generation of new data samples that are similar to the training data and/or modified according to specified conditions. In particular, in the learned reverse diffusion process, the diffusion model can be used to generate new samples that can either replicate the original or produce variations based on the learned data distribution.

In some implementations, denoising diffusion models can operate in either pixel space or latent space, each offering distinct advantages depending on the application requirements. Operating in pixel space means that the model directly manipulates and generates data in its original form, such as raw pixel values for images. For example, when generating images, the diffusion process can add or remove noise directly at the pixel level, allowing the model to learn and reproduce fine-grained details that are visible in the pixel data.

Alternatively, operating in latent space can include transforming the data into a compressed, abstract representation before applying the diffusion process. This can be beneficial for handling high-dimensional data or for improving the computational efficiency of the model. For instance, an image can be encoded into a lower-dimensional latent representation using an encoder network, and the diffusion process can then be applied in this latent space. The denoised latent representation can subsequently be decoded back into pixel space to produce the final output image. This approach can reduce the computational load during the training and sampling phases and can sometimes help in capturing higher-level abstract features of the data that are not immediately apparent in the pixel space.

In some implementations, denoising diffusion models can utilize probability distributions to manage the transformation of data throughout the diffusion process. As one example, Gaussian distributions can be employed in the forward diffusion phase, where noise added to the data is typically modeled as Gaussian. This method can be beneficial for applications like image processing or audio synthesis, where the gradual addition of Gaussian noise helps in creating a smooth transition from original data to a noise-dominated state. However, the model can also be designed to use other types of noise distributions as part of its stochastic process.

In the reverse phase, learned transition distributions can guide the denoising steps. Specifically, a parameterized model (e.g., neural network) can be used to predict the noise to be removed at each step of the reverse phase.

Model parameters can refer to parameter values within the denoising diffusion model that can be learned from training data to optimize the performance of the denoising diffusion model. These parameters can include weights of the neural networks used to predict noise in the reverse diffusion process, as well as parameters defining the noise schedule in the forward process.

The architecture of an example denoising diffusion model can include one or more neural networks. The neural networks can be trained to parameterize the transition kernels in the reverse Markov chain. As examples, the architecture of a denoising diffusion model can incorporate various types of neural networks, such as Convolutional Neural Networks (CNNs) or Recurrent Neural Networks (RNNs).

As a specific example, in some implementations, the neural network architecture can take the form of a U-Net. The U-Net architecture is characterized by its U-shaped structure, which includes a contracting path and an expansive path. The contracting path follows the typical architecture of a convolutional network, including repeated application of convolutions, followed by pooling operations that reduce the spatial dimensions of the feature maps. The expansive path of the U-Net, on the other hand, can include a series of up-convolutions and concatenations with high-resolution features from the contracting path. This can be achieved through skip connections that directly connect corresponding layers in the contracting path to layers in the expansive path.

More generally, the neural network architecture in denoising diffusion models can include multiple layers that can include various types of activation functions. These functions introduce non-linearities that enable the network to capture and learn complex data patterns effectively, although the specific choices of layers and activations can vary based on the model design and application requirements.

Additionally, the architecture can include special components like residual blocks and attention mechanisms, which can enhance the model's performance. Residual blocks can help in training deeper networks by allowing gradients to flow through the network more effectively. Attention mechanisms can provide a means for the model to focus on specific parts of the input data, which is advantageous for applications such as language translation or detailed image synthesis, where contextual understanding significantly impacts the quality of the output. These components are configurable and can be integrated into the neural network architecture to address specific challenges posed by the complexity of the data and the requirements of the generative task.

In some implementations, the training process of a denoising diffusion model can be oriented towards specific learning objectives. These objectives can include minimizing the difference between the original data and the data reconstructed after the reverse diffusion process. Specifically, in some implementations, an objective can include minimizing the Kullback-Leibler divergence between the joint distributions of the forward and reverse Markov chains to ensure that the reverse process effectively reconstructs or generates data that closely matches the training data. As another example, in image processing applications, the objective may be to minimize the pixel-wise mean squared error between the original and reconstructed images. Additionally, the model can be trained to optimize the likelihood of the data given the model, which can enhance the model's ability to generate new samples that are indistinguishable from real data.

Various strategies can be used to perform the training process for diffusion models. Gradient descent algorithms, such as stochastic gradient descent (SGD) or Adam, can be utilized to update the model's parameters. Moreover, learning rate schedules can be implemented to adjust the learning rate during training, which can help in stabilizing the training process and improving convergence. For instance, a learning rate that decreases gradually as training progresses can lead to more stable and reliable model performance.

Various loss functions can be used guide the training of denoising diffusion models. Example loss functions include the mean squared error (MSE) for regression tasks or cross-entropy loss for classification tasks within the model. Additionally, variational lower bounds, such as the evidence lower bound (ELBO), can be used to train the model under a variational inference framework. These loss functions can help in quantifying the discrepancy between the generated samples and the real data, guiding the model to produce outputs that closely resemble the target distribution.

In some implementations, temperature sampling in denoising diffusion models can be used to control the randomness of the generation process. By adjusting the temperature parameter, one can modify the variance of the noise used in the sampling steps, which can affect the sharpness and diversity of the generated outputs. For instance, a lower temperature can result in less noisy and more precise samples, whereas a higher temperature can increase sample diversity but may also introduce more noise and reduce sample quality.

In some implementations, conditional generation can allow the generation of data samples based on specific conditions or attributes. Conditional generation in denoising diffusion models can include modifying the reverse diffusion process based on additional inputs (e.g., conditioning inputs) such as class labels or text descriptions, which guide the model to generate data samples that are more likely to meet specific conditions. This can be implemented by conditioning the model on additional inputs such as class labels, text descriptions, or other data modalities. For example, in a model trained on a dataset of images and their corresponding captions, the model can generate images that correspond to a given textual description, enabling targeted image synthesis.

More particularly, denoising diffusion models can be conditioned using various types of data to guide the generation process towards specific outcomes. One common type of conditioning data is text. For example, in generating images from descriptions, the model can use textual inputs like “a sunny beach” or “a snowy mountain” to generate corresponding images. The text can be processed using natural language processing techniques to transform it into a format that the model can utilize effectively during the generation process.

For example, one type of conditioning data can include text embeddings. Text embeddings are vector representations of text that capture semantic meanings, which can be derived from pre-trained language models such as BERT or CLIP. These embeddings can provide a denser and potentially more informative representation of text than raw text inputs. For instance, in a diffusion model tasked with generating music based on mood descriptions, embeddings of words like “joyful” or “melancholic” can guide the audio generation process to produce music that reflects these moods.

Additionally, conditioning can also include using categorical labels or tags. This approach can be particularly useful in scenarios where the data needs to conform to specific categories or classes.

Classifier-free guidance is a technique that can enhance the control over the sample generation process without the need for an additional classifier model. This can be achieved by modifying the guidance scale during the reverse diffusion process, which adjusts the influence of the learned conditional model. For instance, by increasing the guidance scale, the model can produce samples that more closely align with the specified conditions, improving the fidelity of generated samples that meet desired criteria without the computational overhead of training and integrating a separate classifier.

In some implementations, denoising diffusion models can integrate with other generative models to form hybrid models. For instance, combining a denoising diffusion model with a Generative Adversarial Network (GAN) can leverage the strengths of both models, where the diffusion model can ensure diversity and coverage of the data distribution, and the GAN can refine the sharpness and realism of the generated samples. Another example can include integration with Variational Autoencoders (VAEs) to improve the latent space representation and stability of the generation process.

Efficiency improvements are beneficial aspects of denoising diffusion models. One way to achieve this is by reducing the number of diffusion steps required to generate high-quality samples. For example, sophisticated training techniques such as curriculum learning can be employed to gradually train the model on easier tasks (fewer diffusion steps) and increase complexity (more steps) as the model's performance improves. Additionally, architectural optimizations such as implementing more efficient neural network layers or utilizing advanced activation functions can decrease computational load and improve processing speed during both training and generation phases.

Noise scheduling strategies can improve the performance of denoising diffusion models. By carefully designing the noise schedule—the variance of noise added at each diffusion step—models can achieve faster convergence and improved sample quality. For example, using a learned noise schedule, where the model itself optimizes the noise levels during training based on the data, can result in more efficient training and potentially better generation quality compared to fixed, predetermined noise schedules.

In some implementations, learned upsampling in denoising diffusion models can facilitate the generation of high-resolution outputs from lower-resolution inputs. This technique can be particularly useful in applications such as high-definition image generation or detailed audio synthesis. Learned upsampling can include additional model components that are trained to increase the resolution of generated samples through the reverse diffusion process, effectively enhancing the detail and quality of outputs without the need for externally provided high-resolution training data. In some cases, these additional learned components can be referred to as “super-resolution” models.

In some implementations, denoising diffusion models can be applied to the field of image synthesis, where they can generate high-quality, photorealistic images from a distribution of training data. For example, example models can be used to create new images of landscapes, animals, or even fictional characters by learning from a dataset composed of similar images. The model can add noise to these images and then learn to reverse this process, effectively enabling the generation of new, unique images that maintain the characteristics of the original dataset.

Denoising diffusion models can also be utilized in audio generation. They can generate clear and coherent audio clips from noisy initial data or even from scratch. For instance, in the music industry, example models can help in creating new musical compositions by learning from various genres and styles. Similarly, in speech synthesis, denoising diffusion models can generate human-like speech from text inputs, which can be particularly beneficial for virtual assistants and other AI-driven communication tools.

Other potential use cases of denoising diffusion models extend across various fields including drug discovery, where example models can help in generating molecular structures that could lead to new pharmaceuticals. Additionally, in the field of autonomous vehicles, denoising diffusion models can be used to enhance the processing of sensor data, improving the vehicle's ability to interpret and react to its environment.

In some implementations, the performance of denoising diffusion models can be evaluated using various metrics that assess the quality and diversity of generated samples. The Inception Score (IS) is one such metric that can be used; it measures how distinguishable the generated classes are and the confidence of the classification. For example, a higher Inception Score indicates that the generated images are both diverse across classes and each image is distinctly recognized by a classifier as belonging to a specific class. Another commonly used metric is the Fréchet Inception Distance (FID), which assesses the similarity between the distribution of generated samples and real samples, based on features extracted by an Inception network. A lower FID indicates that the generated samples are more similar to the real samples, suggesting higher quality of the generated data.

Diffusion models can also be used in image segmentation tasks. In this context, the output defines, for each pixel in one or more images, a respective likelihood for each category in a predetermined set of categories. These categories could include simple distinctions such as foreground and background, or more complex classifications such as different object classes. Additionally, diffusion models can be applied to depth estimation tasks, where the output specifies, for each pixel in the images, a respective depth value. Another use case involves motion estimation, where the model processes multiple images to define, for each pixel of one of the input images, the motion of the scene depicted at the pixel between the images in the input set.

Diffusion models can also be effectively utilized for image refinement tasks. In these applications, the input may include slightly degraded or low-resolution images, and the task is to enhance image quality or resolution. The output is a refined image that shows improved clarity, detail, or overall visual appeal. This process can be guided by various types of inputs such as latent encodings that describe desired image attributes or direct image data that serves as a reference for the refinement process. For instance, a diffusion model can take a noisy or compressed image and, using learned representations in its latent space, produce a version that is cleaner or more detailed.

For image synthesis, diffusion models excel by generating entirely new images based on a range of prompts and inputs. These inputs can include natural language descriptions, sketches, or even other images that serve as a style reference. For example, a diffusion model can synthesize a new image from a textual description like “a sunset behind a mountain range,” effectively translating the words into a visual representation. Alternatively, the model might use a simple sketch or an existing image to generate a high-resolution, detailed artwork in a specified style. This capability makes diffusion models particularly valuable in creative fields such as digital art and multimedia production, where generating unique visual content based on abstract or non-visual inputs is beneficial.

FIG. 4A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 4B depicts a block diagram of an example computing device 10 according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 4B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 4C depicts a block diagram of an example computing device 50 according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 4C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 4C, the central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to train a latent diffusion model, the method comprising:
training, by a computing system comprising one or more computing devices, an autoencoder model with a plurality of autoencoder training images, wherein the autoencoder model comprises an encoder model configured to generate a latent representation of an input image within a latent space and a decoder model configured to generate a reconstruction of the input image based on the latent representation of the input image generated by the encoder model, and wherein the plurality of autoencoder training images have a first resolution;
after training, by the computing system, the autoencoder model based on the plurality of autoencoder training images, training, by the computing system, a denoising diffusion model with a plurality of diffusion model training images, wherein the denoising diffusion model is trained within the latent space of the autoencoder, wherein the plurality of diffusion model training images have a second resolution, and wherein the second resolution is greater than the first resolution; and
after training, by the computing system, the denoising diffusion model, outputting, by the computing system, at least the decoder model and the denoising diffusion model as the latent diffusion model.

2. The computer-implemented method of claim 1, wherein the method further comprises:
performing, by the computing system, one or more downsampling operations on a set of original images to generate the plurality of autoencoder training images.

3. The computer-implemented method of claim 1, wherein the plurality of autoencoder training images comprise a plurality of crops from a plurality of source images.

4. The computer-implemented method of claim 3, wherein the method further comprises:
performing, by the computing system, one or more downsampling operations on a set of original images to generate the plurality of source images.

5. The computer-implemented method of claim 4, wherein performing, by the computing system, the one or more downsampling operations on the set of original images comprises performing, by the computing system, two downsampling operations.

6. The computer-implemented method of claim 1, wherein the plurality of autoencoder training images comprise natural images.

7. The computer-implemented method of claim 1, wherein the first resolution comprises 256×256 or smaller.

8. The computer-implemented method of claim 1, wherein the first resolution comprises 224×224 or smaller.

9. The computer-implemented method of claim 1, wherein the second resolution comprises 512×512 or larger.

10. The computer-implemented method of claim 1, wherein the second resolution comprises 1024×1024 or larger.

11. The computer-implemented method of claim 1, wherein the encoder model and the decoder model comprise resolution-flexible models.

12. The computer-implemented method of claim 1, wherein the encoder model and the decoder model comprise fully convolutional models.

13. The computer-implemented method of claim 1, wherein the encoder model and the decoder model perform local attention.

14. The computer-implemented method of claim 1, wherein the method further comprises:
generating, by the computing system, one or more synthetic images with the latent diffusion model, wherein the one or more synthetic images have the second resolution.

15. A computing system comprising a latent diffusion model that has previously been trained by the performance of training operations, the training operations comprising:
training, by a computing system comprising one or more computing devices, an autoencoder model with a plurality of autoencoder training images, wherein the autoencoder model comprises an encoder model configured to generate a latent representation of an input image within a latent space and a decoder model configured to generate a reconstruction of the input image based on the latent representation of the input image generated by the encoder model, and wherein the plurality of autoencoder training images have a first resolution;
after training, by the computing system, the autoencoder model based on the plurality of autoencoder training images, training, by the computing system, a denoising diffusion model with a plurality of diffusion model training images, wherein the denoising diffusion model is trained within the latent space of the autoencoder, wherein the plurality of diffusion model training images have a second resolution, and wherein the second resolution is greater than the first resolution; and
after training, by the computing system, the denoising diffusion model, outputting, by the computing system, at least the decoder model and the denoising diffusion model as the latent diffusion model.

16. The computing system of claim 15, wherein the training operations further comprise:
performing, by the computing system, one or more downsampling operations on a set of original images to generate the plurality of autoencoder training images.

17. The computing system of claim 15, wherein the plurality of autoencoder training images comprise a plurality of crops from a plurality of source images.

18. The computing system of claim 17, wherein the training operations further comprise:
performing, by the computing system, one or more downsampling operations on a set of original images to generate the plurality of source images.

19. The computing system of claim 18, wherein performing, by the computing system, the one or more downsampling operations on the set of original images comprises performing, by the computing system, two downsampling operations.

20. The computing system of claim 15, wherein the plurality of autoencoder training images comprise natural images.
